(19) United States
(12) Patent Application Publication
(10) Pub. No.: US 2001/0029472 A1
(43) Pub. Date: Oct. 11, 2001

(54) Anonymous purchase and sale system for online shopping and delivery services via computer networks

(75) Inventor: Takeshi Hataguchi, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/826,244

(22) Filed: Apr. 4, 2001

(30) Foreign Application Priority Data
Apr. 7, 2000 (JP) P2000-111910

(51) Int. Cl. G06F 17/60

(52) U.S. Cl. 705/26

(57) ABSTRACT

An anonymous purchase and sale system applicable to online shopping using computers between a purchaser and a salesperson is actualized by an anonymous purchase and sale management server, a purchaser terminal device, a salesperson terminal device, an anonymous settlement server and an anonymous delivery system, all of which are linked together via a network. Herein, the anonymous purchase and sale management server activates a commodity sales processor and an analyzer in connection with a sales history storage device, a purchaser's preference storage device and a commodity information storage device. Receiving purchase request information from a purchaser terminal device, the commodity sales processor retrieves from all items of commodity information stored in the commodity information storage device, at least one item of the commodity information that suits to the purchase request information. The purchaser selects a desired item from the retrieved commodity information to send purchasing commodity specifying information to the server, wherein the commodity sales processor generates an order ID. A pair of the order ID and purchasing commodity specifying information are sent to the purchaser terminal device and salesperson terminal device, thus allowing payment of a value for the commodity over the anonymous settlement sever and delivery of the commodity over the anonymous delivery system in connection with the order ID. The purchasing commodity specifying information and purchase request information are respectively registered with the sales history storage device and purchaser's preference storage device for use in provision of information and analysis results for the salesperson.

### BACKGROUND OF THE INVENTION

1. Field of the Invention

This invention relates to anonymous purchase and sale systems for online shopping and delivery services in which users of computers purchase commodities online by way of networks such as the Internet while retaining their anonymity.

2. Description of the Related Art

Recently, various types of computer-related techniques are proposed for online services such as purchases (or bargains) and sales of commodities (or articles) via networks while retaining anonymity of purchasers. For example, Japanese Patent Unexamined Publication No. Hei 10-326310 discloses an example of the commodity purchase system that is configured by the user machine, shop server and bank server. Herein, the bank server receives a shop number, a commodity number and a number of the user's credit card to determine whether to allow purchase of the commodity requested by the user. If the bank server allows the user to purchase the commodity online, it issues a certificate number to make an inquiry to the shop server as to whether the certificate number is effective or not. If the certificate number is acceptable, the shop server sends communication regarding delivery of the commodity to the user machine. Because of the certification of the bank server, the user's credit card number is not transmitted to the shop server. Thus, it is possible to retain anonymity of user's personal information against the shop.

The main purpose of the aforementioned online bargains and sales system is to retain anonymity of the user's personal information such as the credit card numbers. Conventionally, no systems are proposed for the purpose of providing sales history and analysis results to salespersons, sales engineers and sales departments of distributors and stores. Therefore, it is difficult for them to properly make determination as to what kind and how much amount of the commodities should be bought in or laid in stock.

### SUMMARY OF THE INVENTION

It is an object of the invention to provide an anonymous purchase and sale system that is applicable to online bargains and sales via computer networks and that provides sales history and analysis results of purchasing commodities to salespersons, sales departments of distributors and stores while perfectly retaining anonymity of purchasers.

An anonymous purchase and sale system applicable to online shopping using computers between a purchaser and a salesperson is actualized by an anonymous purchase and sale management server, a purchaser terminal device, a salesperson terminal device, an anonymous settlement server and an anonymous delivery system, all of which are linked together via a network. Herein, the anonymous purchase and sale management server activates a commodity sales processor and an analyzer in connection with a sales history storage device, a purchaser's preference storage device and a commodity information storage device. Receiving purchase request information from the purchaser terminal device, the commodity sales processor retrieves from all items of commodity information stored in the commodity information storage device, at least one item of the commodity information that suits to the purchase request information. The purchaser selects a desired item from the retrieved commodity information to send purchasing commodity specifying information to the server, wherein the commodity sales processor generates an order ID for the purchasing commodity. A pair of the order ID and purchasing commodity specifying information are sent to the purchaser terminal device, allowing the purchaser to pay a value of the purchasing commodity online by way of the anonymous settlement sever in connection with the order ID. They are also sent to the salesperson terminal device that is used by the salesperson who sells the purchasing commodity online, allowing the salesperson to receive a remittance via the anonymous settlement server and to proceed to delivery of the purchasing commodity by way of the anonymous delivery system in connection with the order ID. The purchasing commodity specifying information and purchase request information are registered with the sales history storage device and purchaser's preference storage device respectively. It is possible to deliver the purchased commodity to a receiving address such as a convenience store that is designated by the purchaser.

In response to a request from the salesperson, the server transmits information stored in the sales history storage device and/or information stored in the purchaser's preference storage device to the salesperson terminal device, so that the salesperson proceeds to payment of a value for provision of the information online. Alternately, the analyzer analyzes information stored in the sales history storage device and/or information stored in the purchaser's preference storage device, so that analysis results are produced and sent to the salesperson terminal device, then, the salesperson proceeds to payment of a value for provision of the analysis results online.

### BRIEF DESCRIPTION OF THE DRAWINGS

These and other objects, aspects and embodiment of the present invention will be described in more detail with reference to the following drawing figures, of which:

FIG. 1 is a block diagram showing a system configuration for anonymous purchases and sales in online shopping and delivery services in accordance with a preferred embodiment of the invention;

FIG. 2 is a flowchart showing procedures for registration of commodity information with an anonymous purchase and sale management server shown in FIG. 1;

FIG. 3 is a diagram showing transaction of information and data among the purchaser terminal device, anonymous purchase and sale management server and salesperson terminal device with respect to anonymous purchase of commodity under the request of the purchaser;

FIG. 4 is a flowchart showing procedures for the anonymous purchase of the commodity under the request of the purchaser; and

FIG. 5 is a flowchart showing procedures for providing the salesperson with analysis results and information registered in the anonymous purchase and sale management server.

### DESCRIPTION OF THE PREFERRED EMBODIMENT

This invention will be described in further detail by way of examples with reference to the accompanying drawings.

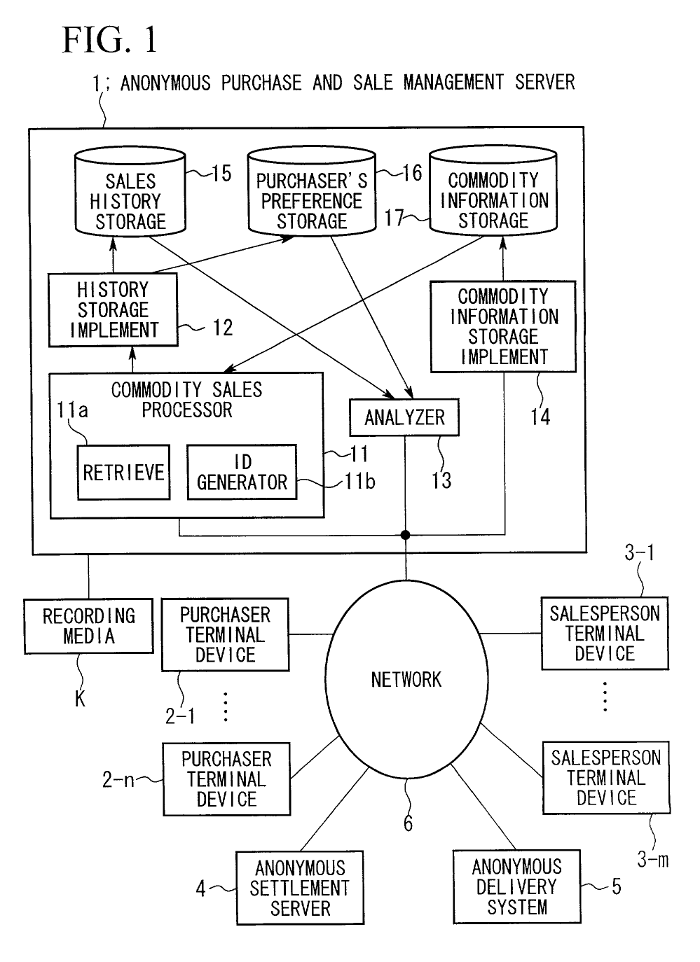

FIG. 1 shows an overall system for anonymous purchases and sales in online shopping and delivery services of commodities in accordance with a preferred embodiment of the invention, wherein the system is configured by an anonymous purchase and sale management server 1, which is computer facilities for use in management of purchases and sales of commodities, purchaser terminal devices (or user's personal computers) 2-1 to 2-n, salesperson terminal devices (or computers of sales agents, sales managers, etc.) 3-1 to 3-m, an anonymous settlement server 4, an anonymous delivery system 5 and a network 6 such as the Internet for linking the devices, servers and systems together.

The salesperson terminal devices 3-1 to 3-m may correspond to personal computers that are used by salespersons (or sales agents, etc.) who sell commodities on the market via computer networks. Each of the salesperson terminal devices has various functions such as transmission functions for transmitting commodity information to the anonymous purchase and sale management server 1 and display functions for displaying pairs of order IDs and purchasing commodity specifying information on screens of displays. Herein, the commodity information correspond to commodities that the salespersons operate keyboards and mouse devices to input into the computers. In addition, the anonymous purchase and sale management server 1 provides the salesperson terminal devices 3-1 to 3-n with the order IDs and purchasing commodity specifying information.

The commodity information include commodity specifying information for specifying commodities and salespersons as well as kinds and characteristics of the commodities. The commodity specifying information is configured by commodity IDs for identifying commodities and salesperson IDs for identifying salespersons. Herein, the commodity IDs are commonly shared among the salespersons. The characteristics of the commodities represent prices, performance, sizes, colors and graphics showing appearances of the commodities. For example, the performance of the personal computers is represented by processing speeds of CPUs, storage capacities of hard disks, memories, and the like. As for business suits, for example, the performance is represented by clothes and fiber materials. Prescribed kinds of commodities are selected in advance for a list of commodities included in the commodity information. So, the salespersons select optimal kinds of the commodities from among the prescribed kinds of the commodities to set them to the commodity information on demand. The purchasing commodity specifying information is configured by commodity IDs and salesperson IDs.

The purchaser terminal devices 2-1 to 2-n may correspond to personal computers that are used by general persons (i.e., purchasers) who wishes to anonymously purchase commodities online. Each of the purchaser terminal devices has various functions regarding procedures for transmission and display. That is, the purchaser terminal device transmits purchase request information, which is input by the purchaser, to the anonymous purchase and sale management server 1. In response to the purchase request information, the anonymous purchase and sale management server 1 sends commodity information, which is displayed on a screen of a display of the purchaser terminal device 2. Then, the purchaser terminal device transmits purchasing commodity specifying information for specifying the commodity, which the purchaser selects to purchase in consideration of the commodity information, to the anonymous purchase and sale management server 1. In response to the purchasing commodity specifying information, the anonymous purchase and sale management server 1 sends a pair of an order ID and the purchasing commodity specifying information, which are displayed on the screen of the display of the purchaser terminal device 2. Incidentally, the purchase request information represent the kind and characteristic of the commodity that the purchaser requests to purchase online.

The anonymous purchase and sale management server 1 contains a commodity sales processor 11, a history storage implement 12, an analyzer 13, a commodity information storage implement 14, a sales history storage device 15, a purchaser's preference storage device 16, a commodity information storage device 17 and recording media K.

The commodity information storage implement 14 registers commodity information, which is sent from the salesperson terminal device 3, with the commodity information storage device 17.

The commodity sales processor 11 contains a retrieve block 11 a and an ID generator block 11b. The retrieve block 11a retrieves from the commodity information registered with the commodity information storage device 17, desired commodity information that suits to the purchase request information. Then, the retrieve block 11a sends the retrieved commodity information to the purchaser terminal device 2 via the network 6. The ID generator block 11b produces an ‘unique’ order ID (consisting of consecutive numbers, for example) to suit to purchasing commodity specifying information that is sent from the purchaser terminal device 2 via the network 6. Thus, the ID generator block 11b sends a pair of the order ID and purchasing commodity specifying information to the purchaser terminal device 2 via the network 6. In addition, it also sends them to the salesperson terminal device 3-j (where 1≦j≦m) used by the salesperson who sells the commodity specified by the purchasing commodity specifying information.

The history information implement 12 registers the purchasing commodity specifying information given from the purchaser terminal device 2 with the sales history storage device 15, and it also registers the purchase request information with the purchaser's preference storage device 16.

In response to a read request given from the salesperson terminal device 3, the analyzer 13 provides the salesperson terminal device 3 with various pieces of information registered with the sales history storage device 15 and purchaser's preference storage device 16 as well as analysis results.

As the recording media K, it is possible to use magnetic disks, optical disks, semiconductor memories and other storage media, which record programs for enabling the computer to function as the anonymous purchase and sale management server 1. Loading the programs from the recording media K, it is possible to actualize functions of the commodity sales processor 11, history storage implement 12, analyzer 13 and commodity information storage implement 14 on the computer.

The anonymous settlement server 4 settles payment of values of commodities that the purchasers purchase online by using order IDs. The anonymous delivery system 5 transfers or delivers commodities to the purchasers in accordance with the order IDs. It is possible to introduce into the anonymous settlement server 4, so-called prepaid cards for payment of values of the commodities, for example. In addition, it is possible to introduce into the anonymous delivery system 5, the prescribed system in which so-called convenience stores (i.e., franchise stores of the twenty-four-hour system) are designated as receiving addresses at which the purchaser can receive the commodities.

Next, descriptions will be given with respect to operations of the present embodiment.

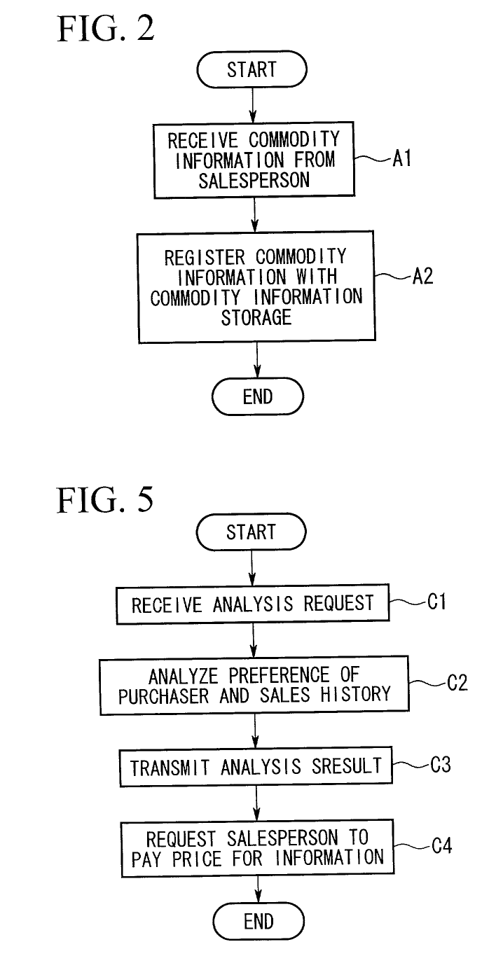

First, a description will be given with respect to salesperson's operations for registering commodity information with the anonymous purchase and sale management server 1 with reference to FIG. 2.

To enable registration of commodity information such as commodity specifying information, kinds and characteristics of commodities that the salesperson sell online, the salesperson operates the salesperson terminal device 3-j to transmit the commodity information to the anonymous purchase and sale management server 1 via the network 6.

In the anonymous purchase and sale management server 1, the commodity information storage implement 14 receives the commodity information sent from the salesperson terminal device 3-j to register it with the commodity information storage device 17 (see steps A1, A2 shown in FIG. 2).

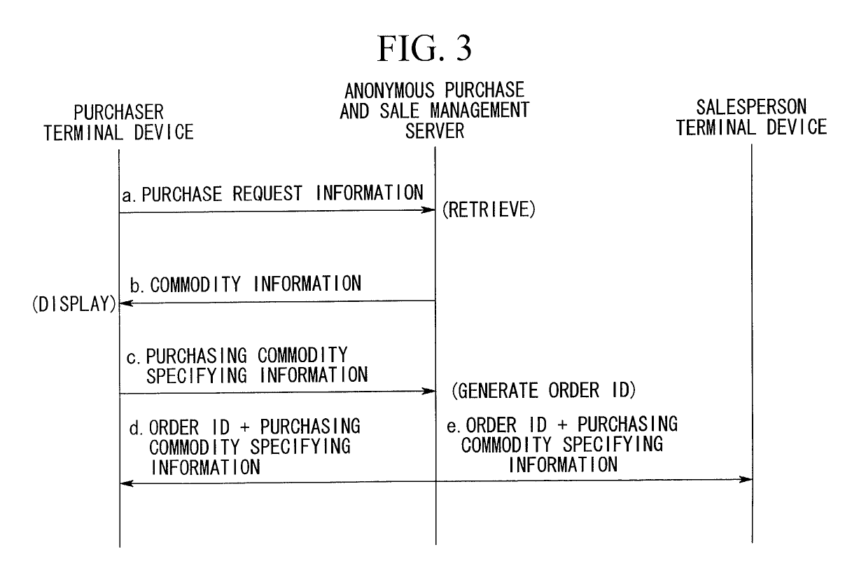

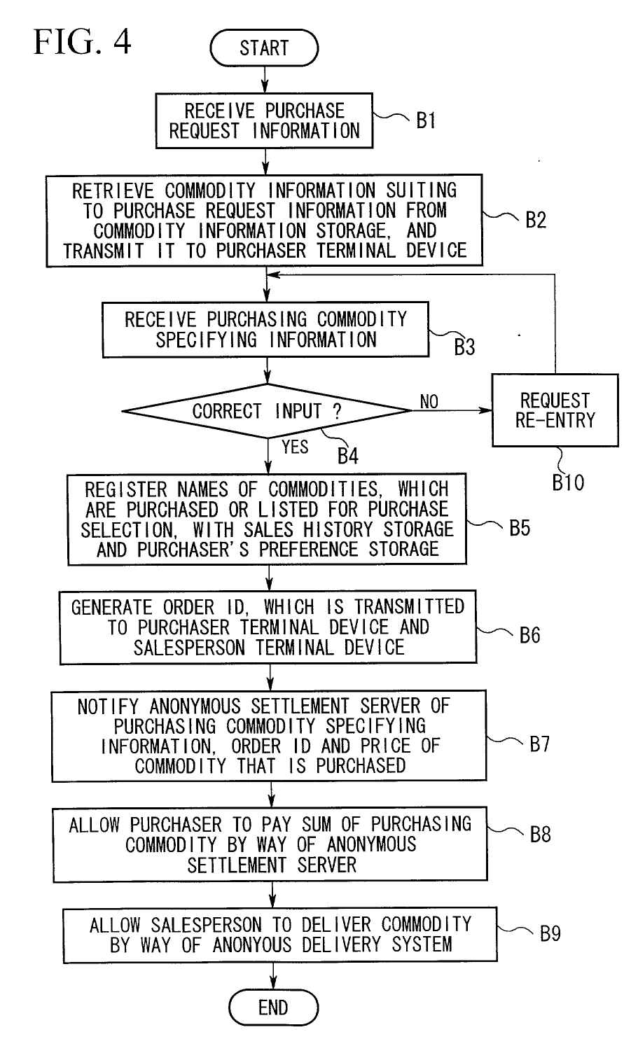

Next, a description will be given with respect to anonymous purchase of commodity with reference to FIGS. 3 and 4. FIG. 3 describes three vertical lines in connection with procedures corresponding to time-series events of three stations, namely the purchaser terminal device, anonymous purchase and sale management server and salesperson terminal device respectively, while five arrows ‘a’ to ‘e’ represent transfer of information data among the three stations.

To realize anonymous purchase of a desired commodity online, the purchaser operates the purchaser terminal device 2-I (where 1≦i≦n) to create purchase request information designating the desired commodity that the purchaser requests to purchase online, wherein the purchase request information includes the kind and characteristic of the desired commodity. The purchaser terminal device 2-i sends the purchase request information to the anonymous purchase and sale management server 1 (see an arrow ‘a’ shown in FIG. 3).

In the anonymous purchase and sale management server 1, the commodity sales processor 11 receives the purchase request information from the purchase terminal device 2-i via the network 6 in step B1 shown in FIG. 4.

The commodity sales processor 11 activates the retrieve block 11a to retrieve from the commodity information storage device 17, commodity information that suit to the purchase request information. Then, the commodity sales processor 11 sends the retrieved commodity information to the purchase terminal device 2-i via the network 6, which is shown by an arrow b in FIG. 3 and step B2 in FIG. 4. For example, the purchaser describes the purchase request information designating specific commodity in connection with various conditions, as follows:

Kind of Commodity:

Personal Computer.

Characteristics:

Processing speed X (MHz) or more.

Hard-disk storage Y (Gigabytes) or more.

Price Z or less.

The retrieve block 11a retrieves from all items of commodity information registered in the commodity information storage device 17, various items of commodity information that meet all of the aforementioned conditions described in the purchase request information, so that the retrieved commodity information is sent to the purchase terminal device 2-i. If the retrieve block 11a fails to find out the commodity information suiting to the aforementioned conditions of the purchase request information, it sends to the purchase terminal device 2-i a communication describing a message that none of the items of the commodity information registered in the commodity information storage device 17 matches with the purchase request information. In addition, it also requests the purchaser to enter new purchase request information into the purchase terminal device 2-i.

Upon receipt of the commodity information from the anonymous purchase and sale management server 1, the purchaser terminal device 2-i displays all items listed in the retrieved commodity information on the screen of the display. If the purchaser finds a desired item within the items of the commodity information displayed on the screen of the display, the purchaser operates the keyboard to input commodity specifying information with respect to the desired item included in the commodity information. Thus, the purchaser terminal device 2-i sends the commodity specifying information to the anonymous purchase and sale management server 1 as purchasing commodity specifying information, which is shown by an arrow c in FIG. 3.

Upon receipt of the purchasing commodity specifying information sent from the purchaser terminal device 2-i in step B3, the flow proceeds to step B4 in which the commodity sales processor 11 of the anonymous purchase and sale management server 1 makes a decision as to whether the purchasing commodity specifying information is contained in the retrieved commodity information (see step B2) or not. If the purchasing commodity specifying information is not contained in the retrieved commodity information so that a decision result of step B4 is “NO”, the flow proceeds to step B10 in which the commodity sales processor 11 communicates with the purchaser terminal device 2-i and requests the purchaser to re-enter the purchasing commodity specifying information. That is, if the purchaser mistakenly inputs wrong purchasing commodity specifying information, the anonymous purchase and sale management server 1 automatically requests the purchaser to re-enter the ‘correct’ purchasing commodity specifying information.

If the purchasing commodity specifying information is correctly input to match with the retrieved commodity information so that a decision result of step B4 is “YES”, the flow proceeds to step B5 in which the commodity sales processor 11 transfers to the history storage implement 12 a pair of the purchase request information, which is received in the step B1, and the purchasing commodity specifying information which is evaluated as ‘correct input’ in the step B4. Thus, the history storage implement 12 registers the purchasing commodity specifying information with the sales history storage device 15, and it also registers the purchase request information with the purchaser's preference storage device 16.

Next, the flow proceeds to step B6 in which the commodity sales processor 11 activates the ID generator block 11b to generate a ‘unique’ order ID with respect to the purchasing commodity specifying information, which is evaluated as ‘correct input’ in the foregoing step B4. Then, the commodity sales processor 11 sends a pair of the order ID and purchasing commodity specifying information to the purchaser terminal device 2-i, which is shown by an arrow d in FIG. 3. In addition, it also sends them to the salesperson terminal device 3-j, which is shown by an arrow e in FIG. 3. Herein, the salesperson can be specified in response to a salesperson ID contained in the purchasing commodity specifying information.

Thereafter, the flow proceeds to step B7 in which the commodity sales processor 11 sends to the anonymous settlement server 4, the order ID, purchasing commodity specifying information and its attributes such as price of the commodity.

Both of the purchaser terminal device 2-i and salesperson terminal device 3-j display on screens of the displays thereof, a pair of the order ID and purchasing commodity specifying information that are sent from the anonymous purchase and sale management server 1. Watching the order ID and purchasing commodity specifying information on the screen of the display of the purchaser terminal device 2-i, the purchaser proceeds to payment of the value of the purchasing commodity online by way of the anonymous settlement server 4 (see step B8). In addition, the purchaser also communicates the order ID to the anonymous settlement server 4 while designating a receiving address at which the purchaser wishes to receive the commodity. The anonymous settlement server 4 compares the order ID and an amount of payment input by the purchaser with the order ID and the value of the commodity informed from the anonymous purchase and sale management server 1. If the order ID and the amount of payment input by the purchaser match with the order ID and the value of the commodity informed from the anonymous purchase and sale management server 1, the anonymous settlement server 4 anonymously makes a remittance to the salesperson who actually sells the commodity to the purchaser in the online shopping. In addition, it also makes a communication describing the order ID and receiving address to the salesperson terminal device 3-j.

Upon receipt of the communication from the anonymous settlement server 4, the flow proceeds to step B9 in which the salesperson accesses the anonymous delivery system 5 to deliver the purchased commodity to the receiving address (e.g., convenience store) that is designated by the purchaser. Incidentally, the salesperson prints the order ID on a prescribed position of the package of the commodity, which allows the purchaser to visually recognize the purchased commodity. The purchaser goes to the designated receiving address and shows the order ID to receive the purchased commodity.

In the aforementioned steps B1 to B9, the anonymous purchase and sale management server 1 merely uses the ‘temporary’ order ID, which is temporarily allocated to the purchasing commodity specifying information from the purchaser, to proceed to payment, transfer and delivery of the commodity without using personal information specifying the purchaser. In addition, the personal information of the purchaser is not at all contained in the information registered in the sales history storage device 15 and purchaser's preference storage device 16. Therefore, by perfectly retaining anonymity of purchasers, the present system can provide salespersons with sales histories, purchaser's preferences and analysis results with respect to purchasing commodities in the online shopping.

Next, a description will be given with respect to the sales history, purchaser's preference and analysis results that are provided for the salesperson with reference to FIG. 5.

In order to obtain the sales history, purchaser's preference and analysis results, the salesperson operates the salesperson terminal device 3-j to send an analysis request, which designates information and data that the salesperson wishes to obtain, to the anonymous purchase and sale management server 1. Herein, the salesperson can design the analysis result according to needs. That is, the analysis request can instruct direct transmission of information that is stored in the sales history information storage device 15 and/or the purchaser's preference storage device 16. Alternately, the analysis request can designate analysis methods for the information stored in the sales history information storage device 15 and/or the purchaser's preference storage device 16, so that the salesperson requests transmission of analysis results of the information in accordance with the designated analysis methods. In this case, the salesperson is able to select from among prescribed analysis methods, which are listed in advance, a desired analysis method on the salesperson terminal device 3. For example, the salesperson is able to select an analysis on colors that the purchasers prefer with respect to certain kinds of commodities, or the salesperson is able to select an analysis on sales volumes with respect to certain kinds of commodities.

In FIG. 5, a flow firstly proceeds to step C1 in which the analyzer 13 of the anonymous purchase and sale management server 1 receives an analysis request that is sent from the salesperson terminal device 3-j via the network 6. In response to the analysis request given from the salesperson, the flow proceeds to step C2 in which the analyzer 13 analyzes the sales history information stored in the sales history information storage device 15 and/or the purchaser's preference information stored in the purchaser's preference storage device 16, thus producing analysis results. In step C3, the analyzer 13 sends the analysis results to the salesperson terminal device 3-j via the network 6. If the analysis request designates direct transmission of information, the sales history information and/or the purchaser's preference information is directly sent to the salesperson terminal device 3-j.

Thus, the salesperson terminal device 3-j shows the analysis results, which are sent from the anonymous purchase and sale management server 1, on the screen of the display. Acknowledging the analysis results and/or information being transmitted from the anonymous purchase and sale management server 1 on the salesperson terminal device 3-j, the salesperson proceeds to payment of the value for the analysis results and/or information online (see step C4).

As described heretofore, this invention has a variety of effects and technical features, which are described below.

(1) This invention teaches the system that is designed to provide salespersons with sales history and analysis results of purchased commodities while perfectly retaining anonymity of purchasers. Because, the system merely uses order IDs to enable settlement of payment, transfer and delivery of commodities between the salespersons and purchasers online. Herein, information and data being provided for the salespersons are strictly restricted to ones such as the purchasing commodity specifying information and analysis results, which do not at all contain personal information of the purchasers.

(2) This invention teaches the system that is designed to provide salespersons with purchaser's preference information while perfectly retaining anonymity of purchasers. Because, the system merely uses order IDs to enable settlement of payment, transfer and delivery of commodities between the salespersons and purchasers. Herein, information and data being provided for the salespersons are strictly restricted to ones such as purchase request information (containing kinds and characteristics of purchasing commodities) and analysis results, which do not at all contain personal information of the purchasers.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to be embraced by the claims.

What is claimed is:

1. An anonymous purchase and sale method applicable to online shopping using computers between a purchaser and a salesperson, comprising the steps of:
receiving purchasing commodity specifying information that is input by a purchaser terminal device to specify a purchasing commodity and is transmitted via a network;
generating an order ID in response to the purchasing commodity specifying information;
sending a pair of the order ID and the purchasing commodity specifying information to the purchaser terminal device and a salesperson terminal device that is used by the salesperson who sells the purchasing commodity online;
registering the purchasing commodity specifying information with a sales history storage device;
in response to a request from the salesperson, sending information stored in the sales history storage device and/or sending analysis results, which are produced by analyzing information stored in the sales history storage device, to the salesperson terminal device.

2. An anonymous purchase and sale method according to claim 1 further comprising the steps of:
receiving purchase request information designating a kind and characteristics of the purchasing commodity from the purchaser terminal device via the network;
retrieving from among all items of commodity information stored in a commodity information storage device, at least one item of the commodity information that suits to the purchase request information; and
sending the retrieved commodity information to the purchaser terminal device, allowing the purchaser to select from the retrieved commodity information, a desired item that the purchaser prefers on the purchaser terminal device.

3. An anonymous purchase and sale method according to claim 1 further comprising the steps of:
receiving purchase request information designating a kind and characteristics of the purchasing commodity from the purchaser terminal device via the network;
registering the purchase request information with a purchaser's preference storage device; and
in response to the request from the salesperson, sending information stored in the purchaser's preference storage device and/or sending analysis results, which are produced by analyzing the information stored in the purchaser's preference storage device, to the salesperson terminal device.

4. An anonymous purchase and sale system applicable to online shopping using computers between a purchaser and a salesperson, comprising:
a commodity sales processor for generating an order ID in response to purchasing commodity specifying information that is input by a purchaser terminal device to specify a purchasing commodity and is transmitted thereto via a network, so that the commodity sales processor sends a pair of the order ID and the purchasing commodity specifying information to the purchaser terminal device and a salesperson terminal device that is used by the salesperson who sells the purchasing commodity online;
a history storage implement for registering the purchasing commodity specifying information with a sales history storage device; and
an analyzer for in response to a request from the salesperson, sending information stored in the sales history storage device and/or sending analysis results, which are produced by analyzing information stored in the sales history storage device, to the salesperson terminal device.

5. An anonymous purchase and sale system according to claim 4 wherein receiving purchase request information designating a kind and characteristics of the purchasing commodity from the purchaser terminal device via the network, the commodity sales processor retrieves from among all items of commodity information stored in a commodity information storage device, at least one item of the commodity information that suits to the purchase request information, so that the retrieved commodity information is sent to the purchaser terminal device, allowing the purchaser to select from the retrieved commodity information, a desired item that the purchaser prefers on the purchaser terminal device.

6. An anonymous purchase and sale system according to claim 4 wherein receiving purchase request information designating a kind and characteristics of the purchasing commodity from the purchaser terminal device via the network, the history information implement registers the purchase request information with a purchaser's preference storage device, so that in response to the request from the salesperson, the analyzer sends information stored in the purchaser's preference storage device and/or sending analysis results, which are produced by analyzing the information stored in the purchaser's preference storage device, to the salesperson terminal device.

7. A computer-readable recording media storing programs that cause a computer system to execute an anonymous purchase and sale method applicable to online shopping using computers between a purchaser and a salesperson, comprising the steps of:
receiving purchasing commodity specifying information that is input by a purchaser terminal device to specify a purchasing commodity and is transmitted via a network;
generating an order ID in response to the purchasing commodity specifying information;
sending a pair of the order ID and the purchasing commodity specifying information to the purchaser terminal device and a salesperson terminal device that is used by the salesperson who sells the purchasing commodity online;
registering the purchasing commodity specifying information with a sales history storage device; and
in response to a request from the salesperson, sending information stored in the sales history storage device and/or sending analysis results, which are produced by analyzing information stored in the sales history storage device, to the salesperson terminal device.

8. A computer-readable media storing programs that cause a computer system to execute the anonymous purchase and sale method according to claim 7 further comprising the steps of:
receiving purchase request information designating a kind and characteristics of the purchasing commodity from the purchaser terminal device via the network;
retrieving from among all items of commodity information stored in a commodity information storage device, at least one item of the commodity information that suits to the purchase request information; and
sending the retrieved commodity information to the purchaser terminal device, allowing the purchaser to select from the retrieved commodity information, a desired item that the purchaser prefers on the purchaser terminal device.

9. A computer-readable media storing programs that cause a computer system to execute the anonymous purchase and sale method according to claim 7 further comprising the steps of:
receiving purchase request information designating a kind and characteristics of the purchasing commodity from the purchaser terminal device via the network;
registering the purchase request information with a purchaser's preference storage device; and
in response to the request from the salesperson, sending information stored in the purchaser's preference storage device and/or sending analysis results, which are produced by analyzing the information stored in the purchaser's preference storage device, to the salesperson terminal device.

10. An anonymous purchase and sale method applicable to online shopping using computers between a purchaser and a salesperson, comprising the steps of:
receiving purchase request information that is input by the purchaser to designate a kind and characteristics of a purchasing commodity on a purchaser terminal device and is transmitted via a network;
retrieving from all items of commodity information stored in a commodity information storage device, at least one item of the commodity information that suits to the purchase request information;
sending the retrieved commodity information to the purchaser terminal device, allowing the purchaser to select a desired item from the retrieved commodity information as the purchasing commodity and to send back purchasing commodity specifying information;
in response to the purchasing commodity specifying information, generating an order ID;
sending a pair of the order ID and the purchasing commodity specifying information to the purchaser terminal device, allowing the purchaser to pay a value of the purchasing commodity online by way of an anonymous settlement sever in connection with the order ID;
sending a pair of the order ID and the purchasing commodity specifying information to a salesperson terminal device that is used by the salesperson who sells the purchasing commodity online, allowing the salesperson to receive a remittance via the anonymous settlement server and to proceed to delivery of the purchasing commodity by way of an anonymous delivery system in connection with the order ID; and
registering the purchasing commodity specifying information with a sales history storage device, while registering the purchase request information with a purchaser's preference storage device.

11. An anonymous purchase and sale method according to claim 10 wherein the anonymous settlement server compares an amount of payment from the purchaser with a value of the purchasing commodity to sends the remittance to the salesperson in connection with the order ID.

12. An anonymous purchase and sale method according to claim 10 wherein the purchaser designates a receiving address for receipt of the purchasing commodity on the purchaser terminal device, so that the salesperson accesses the anonymous delivery system to deliver the purchased commodity to the designated receiving address in connection with the order ID.

13. An anonymous purchase and sale method according to claim 10 further comprising the step of:
in response to a request from the salesperson, transmitting information stored in the sales history storage device and/or information stored in the purchaser's preference storage device to the salesperson terminal device, so that the salesperson proceeds to payment of a value for provision of the information online.

14. An anonymous purchase and sale method according to claim 10 further comprising the steps of:
in response to a request from the salesperson, analyzing information stored in the sales history storage device and/or information stored in the purchaser's preference storage device, thus producing analysis results; and
sending the analysis results to the salesperson terminal device, so that the salesperson proceeds to payment of a value for provision of the analysis results online.
